(19) United States
(12) Patent Application Publication
(10) Pub. No.: US 2011/0208848 A1
(43) Pub. Date: Aug. 25, 2011

(54) NETWORK SYSTEM OF WEB SERVICES BASED ON SEMANTICS AND RELATIONSHIPS

(76) Inventors: Zhiyong Feng, Tianjin (CN); Shizhan Chen, Tianjin (CN); Hui Wang, Tianjin (CN); Ju Chen, Tianjin (CN); Leng Han, Tianjin (CN)

(21) Appl. No.: 12/596,587

(22) PCT Filed: Dec. 11, 2008
(86) PCT No.: PCT/CN2008/073447

§ 371 Date: Oct. 19, 2009

(30) Foreign Application Priority Data
Aug. 5, 2008 (CN) 200810054066.3

(51) Int. Cl. G06F 15/16

(52) U.S. Cl. 709/223

(57) ABSTRACT

The invention has disclosed a network system of web services based on semantics and relationship. The Service Network is used in automatic discovery and (semi-)automatic composition. The service to be processed of Service Network derives from registration service and extraction service of network. Submission service extracts information and sends it to Service Network according to service registry query. Extraction service obtains the service description file with crawler and register to Service Network via interface of service registry; and composition service is automatically done according to custom's function description, the complex service is sent to Service Network. The invention is more convenient for announcement of Web services, service discovery and (semi-) automatic composition based on semantics. It can extend and combine various service semantic description languages; and construct services ecosystem with available Web services, and improve operation of automatic service composition, searching and maintenance with the help of relationship among services.

### CROSS REFERENCE TO RELATED APPLICATIONS

This application claims priority benefit under 35 U.S.C. §120 of PCT/CN2008/73447, which, claims priority benefit under the Paris Convention of Chinese Patent Application No. 200810054066.3, filed Aug. 5, 2008. The contents of all two applications are hereby incorporated by reference.

### FIELD OF THE INVENTION

The invention relates to a description and discovery service network system based on internet. More particularly, the invention relates to the organization of service information based on Web application, such as registration, administration, access mechanisms.

### BACKGROUND OF THE INVENTION

At present, Web services registry usually adopts UDDI specification and the like to describe corporation and the Web services it offers by using XML document, in addition to the maintenance of the global catalog of the Web services. Because of the lack of semantic description of the relationship among Web services, the Web services registration model based on UDDI or its variants has drawbacks as follows:

1) Only basic information of Web services such as name and field is stored in registry, as a result the services can only provide discovery and matching based on key words, what leads to low recall and precision rate of Web services.

2) Because of the lack of description of semantic properties, Web services discovery can not be realized via the characteristics of semantic properties in applications aimed at business process integration.

3) Because of the lack of description of relationship among Web services, a more flexible and available service classification mechanism can not be provided.

4) The service discovery algorithm which focuses on the demand of function can not satisfy the demand of QoS.

5) Further support to automatic Web services composition is lacking.

At present, many researches are devoted to modifying the drawbacks of present UDDI registry model, for example, improving recall rate by ontology technology and search efficiency by hash table, however, the main problems of present Web services registry model stated above are not significantly solved.

### SUMMARY OF THE INVENTION

Because of the existing problems in present technology stated above, the invention provides a social network system of web services based on semantics and relationship to construct the Web services ecosystem. Through re-concluding and rearranging, data from present Web services registry and various scattered Web services information will be transformed into ontology form. With mining the relationship among Web services by mining algorithm, Web services registry centers will be organized into a network system using Web services as nodes and relationship among services as edges, thereby the service discovery and (semi-) automatic service composition which are dynamic, independent and based on semantics are realized.

The invention provides a social network system of web services based on semantics, named Service Network (SN), which takes Web services as its nodes and forms a three-dimensional network with the relationship among services. The network system consists of two layers: abstract service layer and concrete (practical) service layer, which contain abstract service and concrete (practical) service respectively with the characteristics that the system includes Service Network, its service submission system and service discovery system, its (semi-) automatic service composition system based on function description and interface of service query and display, wherein:

Service Network is used in automatic service discovery and (semi-) automatic service composition. The service to be processed of Service Network originates from submission service and access service of the network. Submission service includes service submission/service information extraction which is sent to Service Network. Access service sends description files with service to Service Network via interface of service discovery and display. And composition services request based on function description is also sent to Service Network via interface of service discovery and display. The function of discovery service which is provided by Service Network is realized via semantic reasoning and relation calculus.

Concrete (practical) service above is a specialization of abstract service. Concrete (practical) service and abstract service of Service Network are connected by Instance-of.

Concrete (practical) services above are connected by service relationship defined as following including; equivalence relationship, replacing relationship, similar relationship, composition relationship, invocation relationship, time constraints relationship and location relationship.

The structure of nodes are defined according to conventional subsets of description part of Web services properties in OWL-S and WSDL files selected correspondingly, meanwhile, corresponding nodes provide URI properties pointing to former OWL-S or WSDL files.

WSDL files above adopt WSDL2SN parser to parse and generate nodes of Service Network, then insert into Service Network. The implementing process of WSDL2SN parser above includes the following steps;

Firstly, WSDL file is read into definition through WSDL4J API;

Read and get types definition from “definition”;

Construct properties information such as naming paces, etc, and transform the property to JDOM type;

Obtain the schema definition of type which is transformed.

In the situation that parameters in WSDL file are custom complex type, it is necessary to use schema above to make complex type parse until custom type is decomposed to get a series of simple types. Thus, there are following steps after the flow above;

At first, service elements are parsed to get binding information;

Based on the binding information, find corresponding portType information;

All operations contained in portType are parsed to obtain basic property and parameter information of individual operation. Each input and output result is a message respectively;

According to parameter information, find corresponding message definition;

Concrete (practical) structure of message is obtained from schema where it has been constructed until message is decomposed to a series of simple types;

Determine binding types and then divide them into RPC type and coding type;

When binding type is RPC type, construct complex parameter of RPC type;

Determine if the constructed RPC type complex parameter is complex type;

Obtain complete service information;

When binding type is coding type, construct complex parameter of document type;

Determine if the constructed document type complex parameter is complex type;

Obtain complete service information.

OWL-S file above adopts OWL-S parser to make parse, which includes the following steps:

At first OWL-S file is read through URI of OWL-S;

Import other ontology quoted by OWL-S;

Check if the ontology described by the file above is effective and meets the specification;

If the check result of ontology above is effective and meets the specification, then related contents needed by service nodes which construct service network are parsed;

Map it into the specification which conforms to service network definition;

Persist the result into service network, and inform corresponding maintenance program;

Inform update to maintenance process of Service Network;

If the check result of ontology above is ineffective and can not meet the specification, then related information is exported and this operation is over.

The corresponding service relationship mining algorithm adopted in Web services relation network has the following steps:

At first, two services are pretreated to extract function description tag (tag) and operation interface of services; then calculate the relationship between two tags and two service operation interfaces respectively; service relationship is obtained by weighting according to a certain weighting value; update service network according to service relationship, and algorithm is over.

The algorithm further includes calculating flow of service operation interface relationship which has the following steps:

At first, two operation interfaces are pretreated; judgement is conducted to determine if the interface names and description information is opposite (contradictory). If it is, then operation flow is over. If not, then calculation of the relationship of input and output parameters is conducted; afterwards, relationship type and similarity of operation interfaces are obtained and algorithm is over.

The system stated above also includes manual operation interfaces.

Compared with state of the art, the invention is more convenient in discovery, composition and making matching of Web services, and extends and combines various service semantic description languages with ease of use; can be utilized in construction of services ecosystem with available Web services, and in improving operation of service composition, searching and maintenance with the help of relationship among services.

### BRIEF DESCRIPTION OF THE DRAWINGS

FIG. 1 is a sketch map of formation of Service Network based on semantics and relationship of the invention;

FIG. 2 is a sketch map of a social network system of Web services based on semantics and relationship of the invention;

FIG. 3 is a flow chart of conversion of different description types of various Web services model converters;

FIG. 4 is a flow chart of realization of WSDL2SN parser appropriate to WSDL file;

FIG. 5 is a flow chart of realization of OWL-S2SN parser appropriate to OWL-S file;

FIG. 6 is whole a frame diagram of Service Network of the invention;

FIG. 7 is a flow chart of calculation of operation interface relationship of service relationship mining algorithm of the invention;

FIG. 8 is a flow chart of calculation of service relationship mining algorithm of the invention.

### DESCRIPTION OF THE EMBODIMENT

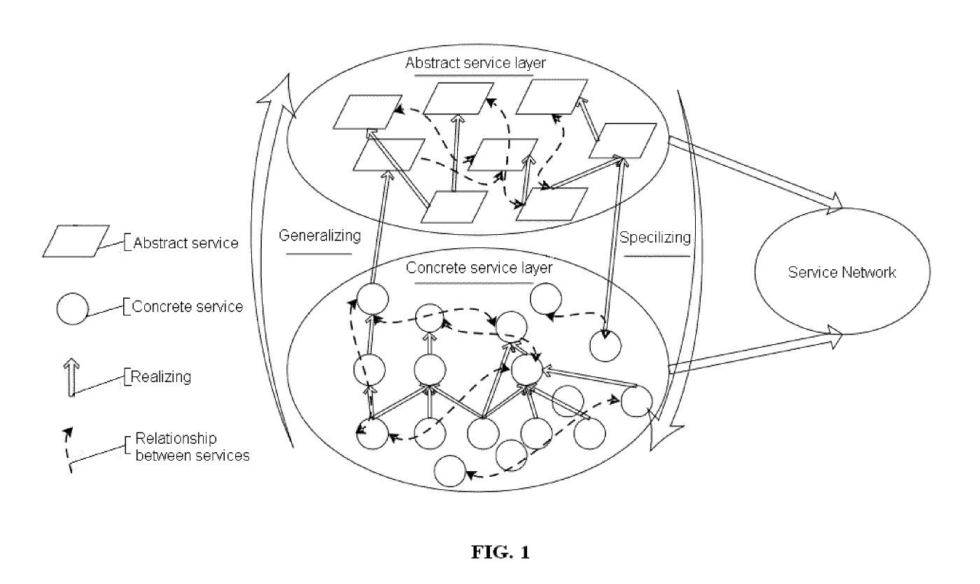

FIG. 1 is a sketch map of formation of Service Network based on semantics and relationship of the invention. At first Service Network system obtains a few independent Web services from traditional Web services registry without semantics, digs out various relationship among each service and forms concrete (practical) service network layer. Meanwhile, the function of each service is generalized and the abstraction of common character is obtained to form abstract service network layer. An overall composition is Web services ecosystem based on semantics and relationship of the invention, named Service Network.

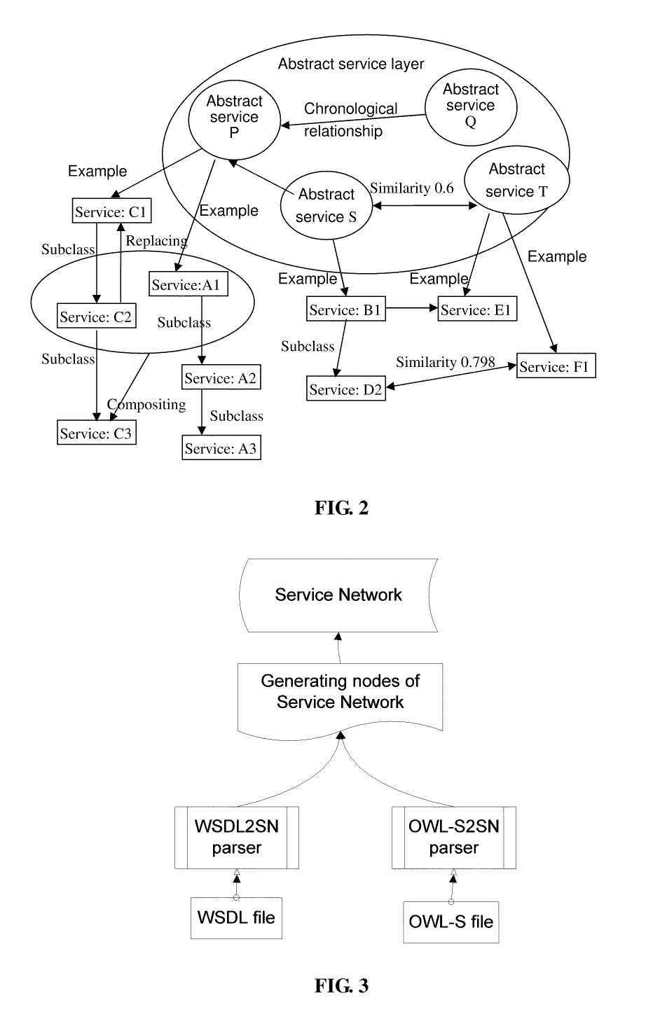

FIG. 2 is a sketch map of Service Network of the invention. The network system of service relationship is based on services as its node and a three-dimensional network consisting of relationship among services. It consists of two layers: abstract service layer and concrete (practical) service layer, including abstract service and concrete (practical) service respectively. The service relationship of Service Network mainly includes the following six types:

1. Equivalence Relationship: interface properties (including input/output interfaces) of this type of service are entirely identical. The realized functions are entirely identical and can be replaced with each other. Moreover, the establishment of the relationship has nothing to do with concrete (practical) realization of service;

2. Replacement Relationship: there is a directed replacement relationship among this type of services, for example, service B can realize all functions of service A, therefore, service B is available to replace service A (Conversely, it is not true);

3. Similarity Relationship: for example, part of functions of (unidirectional) service S and service T overlap (similarity is 0.6 as shown in FIG. 2), therefore, it is called that service B is similar to service A and service A is similar to service B, but the similarities of them may be different (The similarity of service A to service B may be different from that of service B to service A);

4. Composition Relationship: the realization of service P consists of service A1, A2, A3, etc. AS a result, there is composition relationship between A1 and service P. With regard to composition relationship, the order of composition should be considered above all. That means what the construction of service composition is, what the order of invocation is, where to put the control information about composition and how to obtain the control information. The orders of invocation include the following types: sequential call, loop call, branch call, etc. OWL-S standard supports several control construction above, such as: Sequence, Split, Split+Join, Unordered, Choice, If-Then-Else, Iterate and Repeat-Until, etc;

5. Invocation Relationship: when service B1 calls service E1, there is invocation relationship between service B1 and service E1. The invocation relationship often co-exists with composition relationship;

6. Time-constraint Relationship: it refers to the sequence of time when different services happens, for example, service P must be run before service Q.

Concrete (practical) service of the network system of service relationship is an realization of abstract service. Concrete (practical) service and abstract service are connected by Instance-of.

Property parameters of service nodes include:
Interface property: IOPE i.e. Input, Output, Precondition and Effect.
Function description (it is tag or class): the function and characteristic of service are described in the form of key words, and the classification of services is based on the description above. The services which have same key words are the same type.
Information of service provider: for example, name, contacts (telephone number, email). When customer can only access this service yet it is not available, customer can contact with service provider to make it available by consultation.
URI: service address.
D-URI: URI of description file.
Composition service property: if it is atomic service, then use “atomic” as property value. If it is composition service, then use “cmp” as property value.
Privilege information: username/password. It may be required for paid service.
Service creating time: (modifying time at each time).
Service quality: including Stability, Reliability, Service Cost and Grade. Stability is used to describe the difference of response time of the same Web services needed at different call time; Response time is the time span from the sending executive request to obtaining the response information. Reliability represents the degree of ability of maintenance service and its quality; Service Cost is the payment the customer needs to pay for the service; Grade is used to describe the evaluation of customer who used the Web services they called.

In Service Network based on semantics and relationship stated in this invention, the structure of nodes are defined according to conventional subsets of description part of Web services properties in OWL-S and WSDL files selected correspondingly. This method is not only able to ensure the brevity and clarity of Web services structure, but also to keep the integrity of information and the ease of realization.

The invention mainly adopts the description of service ontology to show Service Network.

Because Service Network of the invention different from various ways of service description of present technology, a structure of nodes which is simple but keeps the information of former description file is defined to ensure that the network system of service relationship is compatible with all kinds of different ways of Web services description of present technology. At first, the process should parse different ways of description, and the parse process is shown in FIG. 3 which includes the following steps:

For WSDL file, it is parsed by WSDL2SN parser to form the nodes of Service Network and then form network system of Web services.

For OWL-S file, it is parsed by OWL-S2SN parser to form the nodes of Service Network and then form network system of Web services.

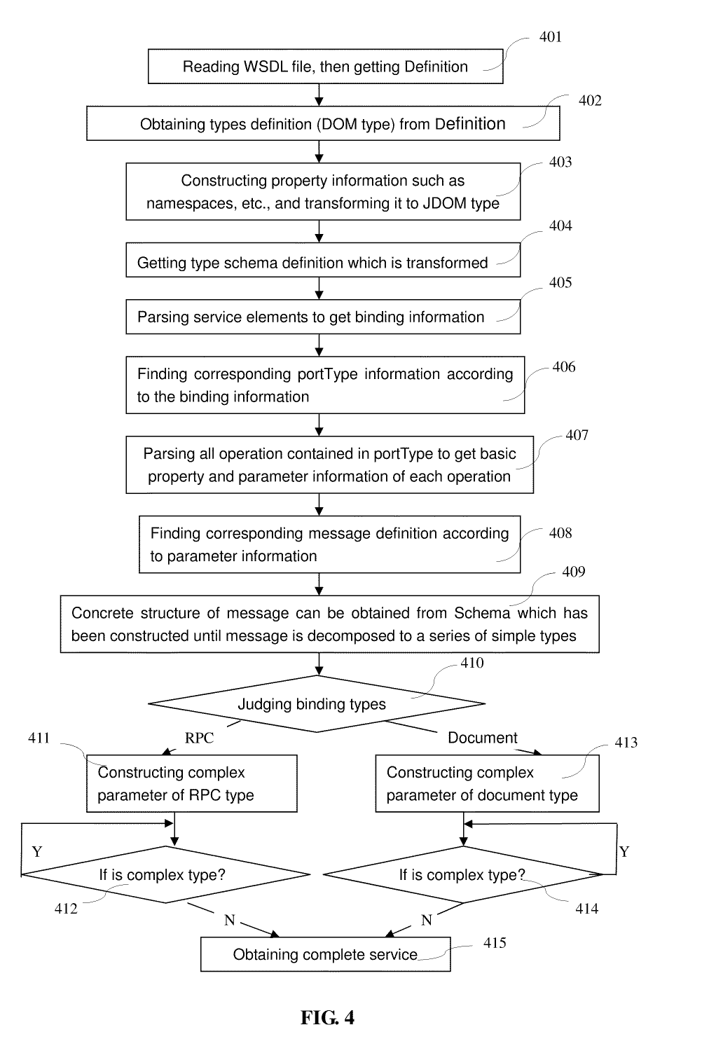

The parse process of WSDL2SN parser which is from step 401 to step 404 shown in FIG. 4 includes the following steps:

Firstly, WSDL file is read into definition through WSDL4J API, step 401; Read and get types definition (DOM type) from definition, step 402; Construct properties information such as namespaces, etc. and transform the property to JDOM type, step 403; Get type schema definition which is transformed, step 404; The type schema definition will be used when parsing the custom parameter type.

In the situation that parameters in WSDL file are custom complex type, it is necessary to use schema above to make complex type parse until custom type is decomposed to get a series of simple types. This part of process which is from step 405 to step 415 includes the following steps:

Step 405: At first, service elements are parsed to get binding information. It means the elements are parsed to tag of <wsdl:service> to find binding information of each tag of <wsdl:port> at the back of “binding”;

Step 406: According to the binding information, find corresponding portType information. It means to find portType property from tag of <wsdl:binding> which is the name of main interface provided by the service.

Step 407: All operation contained in portType are parsed to get basic property and parameter information of each operation. It means to find each operation from <wsdl:portType>. Each operation of <wsdl:operation> has its own input and output, and each input and output result is a message respectively;

Step 408: According to parameter information, find corresponding message definition. It means to find the basic element of each message from <wsdl:message>. It may be a composite of simple type and complex custom type. If it is simple type, then the parse process is over;

Step 409: Concrete structure of message can be obtained from schema which has been constructed until message is decomposed to a series of simple types. It means if the composite of message is complex custom type, then it is necessary to find the definition of the complex type from type definition recursively until composite type is complete simple type;

Step 410: Judge binding types and then divide them into RPC type and coding type;

Step 411: When binding type is RPC type, construct complex parameter of RPC type;

Step 412: Judge if the constructed RPC type complex parameter is complex type;

Step 415: Get complete service information;

Step 413: When binding type is coding type, construct complex parameter of document type;

Step 414: Judge if the constructed document type complex parameter is complex type;

Step 415: Get complete service information.

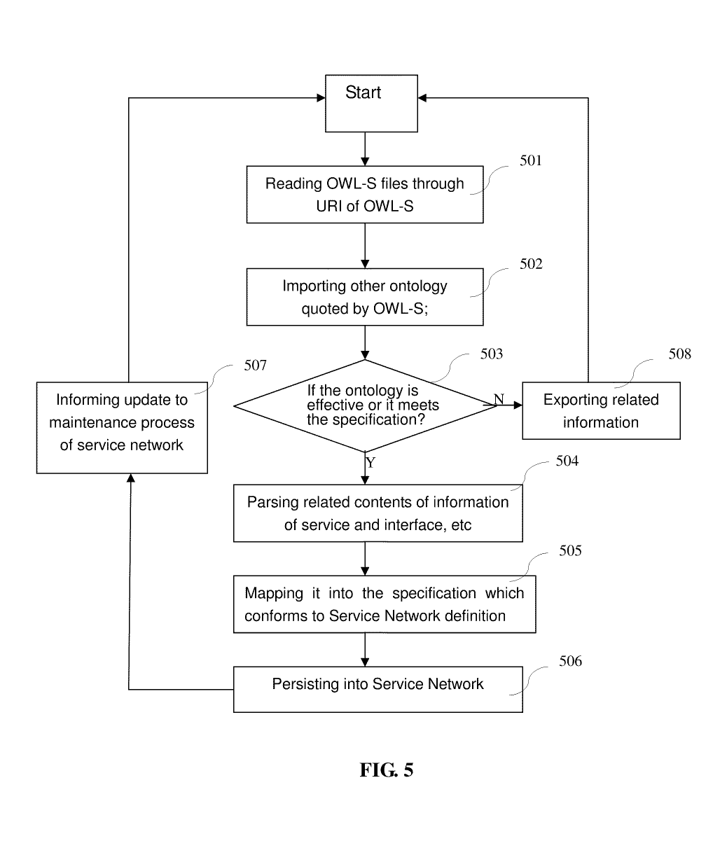

FIG. 5 is a flow chart of realization of OWL-S2SN parser which includes the following steps:

Step 501: At first OWL-S file is read through URI of OWL-S. It means to obtain the URI of OWL-S file which is parsed, read the file and other ontology files which are quoted;

Step 502: Import other ontology quoted by OWL-S;

Step 503: Check if the ontology described by the file above is effective and meets the specification. It means if there is any conflict of semantics and if it meets the specification of OWL-S;

Step 504: If the check result of ontology above is effective and meets the specification, then related contents needed by service nodes which construct service network are parsed;

Step 505: Map it into the specification which conforms to service network definition. It means to format the parse result to the form which conforms to service network definition.

Step 506: Persist the result into service network, and inform corresponding maintenance program;

Step 507: Inform update to maintenance process of service network;

Step 508: If the check result of ontology above is ineffective and can not meet the specification, then related information is exported and this operation is over.

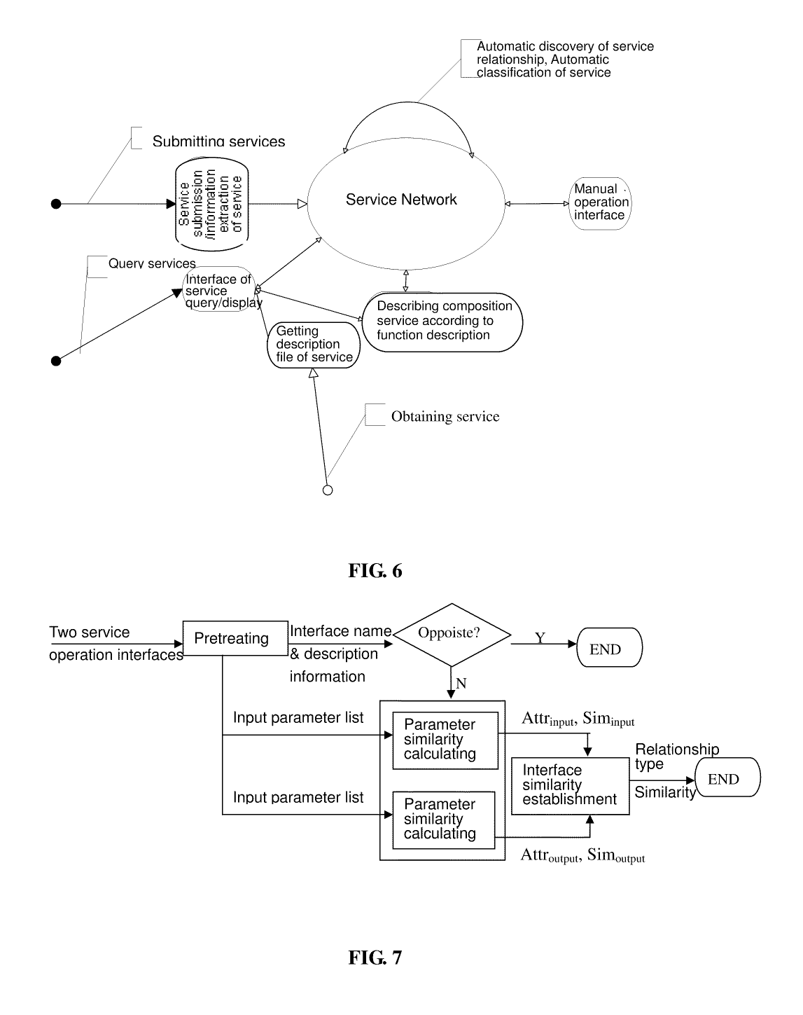

FIG. 6 is a frame diagram of Service Network based on semantics and relationship of the invention. Service Network is used in automatic service discovery and (semi-) automatic service composition. The service to be proceeded of Service Network is from the service submitted by customs; composition service automatically generated by Service Network; Service Network extracts publicly service by using web crawler to search from internet. Submitting service includes service submission/information extraction which is sent to Service Network; Service Network will (semi-)automatically generate new composition service according to custom's request and a description file of the Web services which is taken as a case to save in Service Network while submitting the service to custom; extraction service sends the description file getting service to Service Network via service additional interface; function of service query of Service Network is done via interface of service discovery/display.

The Service Network also includes manual operation interface to manually operate discovery service, register service and composition service provided by Service Network.

In order to realize the invention, service ontology is constructed based on semantics web technology and the relationship mining algorithm corresponding with design is used. For service relationship mining, it is to do that calculating the logical relationship of services in general service world. Detailed value is required to measure the similarity grade among services, but the relationship among services greatly depends on the relationship among service operations.

FIG. 7 is the calculation flow of operation relationship of service relationship mining algorithm which has the following steps:

At first, two operations are pretreated; determine if the operation name and description information are opposites or not. If it is true, then operation flow is over. If not, then calculate the similarity of input and output parameters; afterwards, similarity of operations is established, relationship type and similarity are obtained and algorithm is over.

The following instruction is about the concrete (practical) implications of some process steps of the algorithm:

“Pretreating” module is pretreatment to operation interface including the segmentation and analysis of operation interface name, the extraction of key words of description information and list of input and output parameters.

The description of operation and its name only provide the reference. It is no longer considered if it is not opposite.

“Parameter similarity calculating” module is used to calculate the similarity grade of two parameters. The similarity calculating ways of input parameter list and output parameter list are the same, and it is called similarity calculating of parameter list below. Only when calculating the relationship of operation interface finally, the ratios of input and output are different. In the ordinary, the ratio of output is higher than that of input because people pay more attention to the matching of output.

Generally, list of service parameters is not only simple data type, but contains concept of semantic information. In this invention, similarity calculating of parameter list can be considered as the similarity calculating of two groups of concepts.

At first, it is necessary to explain the calculating method of similarities between two concepts. Concept similarity represents the similarity between two concepts in ontology. It is needed to explain that only the two concepts in one ontology has similarity, similarity of concepts in different ontology are considered as zero (concepts in different ontology can be considered in the future). Similarity of concepts in ontology is related to semantic distance among concepts. Similarity of single concept can be obtained with correlated similarity function.

The similarity of two groups of concepts can be calculated by using optimum matching method of weighted bipartite graph. Two groups of concepts are considered as two groups of vertexes, and similarity among operation is weighting value of edge (For convenience, set a threshold for similarity. The edge does not exist if it is lower than the threshold). The invention confirms the matching among parameter lists according to classic kuhn-munkres algorithm.

In “service relationship establishment” module, similarity relationship among operation interfaces is eventually confirmed according to similarity value and property of input and output concept lists.

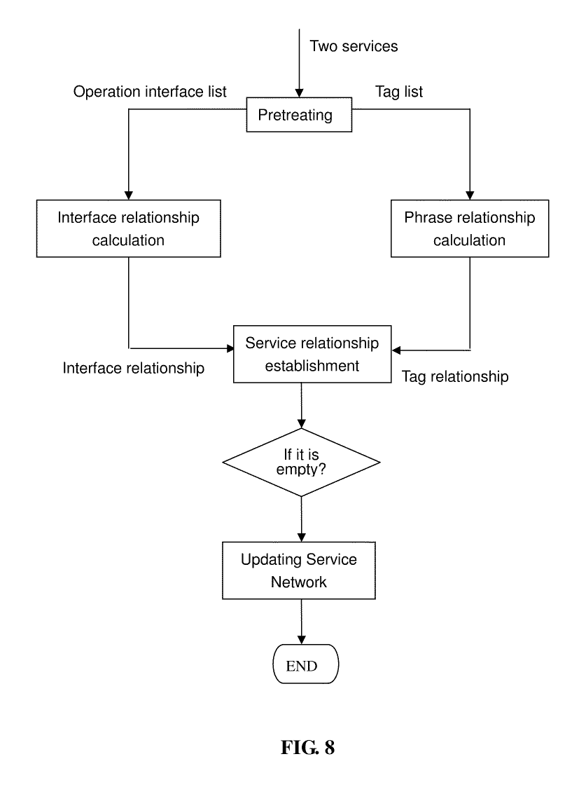

FIG. 8 is a flow of calculation of operation service relationship of the invention. It has the following steps:

At first, two services are pretreated to extract function description tag (tag) and operation of services; then calculate the relationship between two tags and two service operation interfaces respectively; service relationship is obtained by weighting according to a certain weighting value; update service network according to service relationship, and algorithm is over.

The following instruction is about the concrete implications of some process steps of the algorithm:

“Pretreating” module is some pretreating work to service operation to extract function description tag (tag) and operation of services.

In “interface relationship calculation” module, two groups of operations are considered as input and matched by pairs. With the algorithm shown in FIG. 7, similarity value and relationship type in two groups of operations matched by pairs are obtained by using optimum matching method of weighted bipartite graph. Two groups of operation are considered as two groups of vertexes, and similarity among operation is weighting value of edge (For convenience, set a threshold for similarity. The edge does not exist if it is lower than the threshold). Thus similarity and relationship type of two groups of operation is confirmed. The invention also confirms the matching among operation interfaces according to classic kuhn-munkres algorithm.

In “phrase relation calculation” module, two groups of tags are considered as input and matched by pairs. Similarity and relationship type of phrase are calculated based on WordNet semantic dictionary to obtain the similarity and relationship type of two groups of tags matched by pairs by using optimum matching method of weighted bipartite graph. Two groups of tags operation are consider as two groups of vertexes, and similarity among phrase is weighting value of edge (For convenience, set a threshold for similarity. The edge does not exist if it is lower than the threshold). Thus similarity and relationship type of two groups of operation are confirmed.

In “service relationship establishment” module, service relationship is confirmed according to a certain weighting value via operation interface relationship and tag relationship. If service relationship exists, update service network via “updating service network” module and algorithm is over; otherwise, algorithm is over directly.

The content above is the embodiment of the invention. It is not the purpose to restrict the system of the invention. The extent of protection of the patent right for invention shall be determined by the terms of the claims. Without departing from the scope of the present invention, any kind of apparent modification and changes in form and details to it will fall within the terms of the claims for invention.

1. A network system of web services based on semantics and relationship which is based on Web services as its node and a three-dimensional network consisting of relationship among services; it is divided into two layers: abstract service layer and concrete service layer, including abstract service and concrete service respectively, wherein the system includes Service Network, the web submission service and the web extraction service, a complex service automatically assembled based on function description and interface of service discovery and display, the Service Network is used in automatic discovery and dynamic composition, the service to be processed of Services Network is from registration service and discovery service of the network; wherein said Registration service includes service submission/the extraction of service information which is sent to Service Network; discovery service obtains the service description file with crawler and registers to Service Network; and service composition is automatically done according to function description, the complex service is sent to Service Network via interface of service registry; and the function of query/display service which is provided by Service Network is realized via interface of service discovery.

2. A network system of web services based on semantics and relationship according to claim 1, wherein said concrete service is a specialization of abstract service, the concrete service and the abstract service of Service Network based on semantics and relationship are connected by Instance-of.

3. A network system of web services based on semantics and relationship according to claim 1, wherein among said concrete services are connected by relationships defined as following which include: equivalence relationship, replacing relationship, similar relationship, composition relationship, invocation relationship, time constraint relationship.

4. A network system of web services based on semantics and relationship according to claim 1, wherein the structure of said nodes are defined according to conventional subsets of description part of Web services properties in OWL-S and WSDL files selected correspondingly, meanwhile, corresponding nodes provide URI properties pointing to former OWL-S or WSDL files.

5. A network system of web services based on semantics and relationship according to claim 4, wherein said WSDL files are parsed by WSDL2SN parser and created nodes of Service Network, then constituted Service Network, the implementing process of said WSDL2SN parser includes the following steps:
firstly, WSDL file is read into definition through WSDL4J API;
reading and getting types definition from definition;
constructing properties information such as namespaces, etc., and transforming the property to JDOM type;
obtaining type schema definition which is transformed;
in the situation that parameters in WSDL file are custom complex type, it is necessary to use schema above to make complex type parse until custom type is decomposed to get a series of simple types; thus, it further includes the following steps in addition to the flow above:
at first, service elements are parsed to get binding information;
finding corresponding portType information according to the binding information;
parsing all operation contained in portType to get basic property and parameter information of each operation; where in each input and output result is a message respectively;
finding corresponding message definition according to parameter information;
concrete structure of message is obtained from schema which has been constructed until message is decomposed to a series of simple types;
judging the binding types and then dividing them into RPC type and coding type;
constructing complex parameter of RPC type when binding type is RPC type;
judging if the constructed RPC type complex parameter is complex type;
obtaining complete service information;
constructing complex parameter of document type when binding type is coding type;
judging if the constructed document type complex parameter is complex type or not;
obtaining complete service information.

6. A network system of web services based on semantics and relationship according to claim 4, wherein said OWL-S file adopts OWL-S parser to make parse, which includes the following steps:
at first, OWL-S file is read through URI of OWL-S;
importing other ontology quoted by OWL-S;
checking if the ontology described by the file above is effective and meets the specification;
if the check result of ontology above is effective and meets the specification, then related contents needed by service nodes which construct service network are parsed;
mapping it into the specification which conforms to service network definition;
persisting the result into service network, and inform corresponding maintenance program;
informing update to maintenance process of service network;
if the check result of ontology above is ineffective and can not meet the specification, then related information is exported and this operation is over.

7. A network system of web services relationship based on semantics according to claim 1, Wherein the corresponding service relationship mining algorithm adopted in said Web services relation network has the following steps:
at first, two services are pretreated to extract function description tag (tag) and operation interface of services; then calculating the relationship between two tags and two service operation interfaces respectively; service relationship is obtained by weighting according to a certain weighting value; updating service network according to service relationship, and algorithm is over;
the calculating flow of service operation interface relationship has the following steps: at first, two operation interfaces are pretreated; judge if the interface name and description information are opposites or not, if it is, then the operation flow is over; if not, then calculate the relationship of input and output parameters; afterwards, relationship type and similarity of operation interface are obtained and algorithm is over.

8. A network system of web services based on semantics and relationship according to claim 1, wherein said system also includes manual operation interface.
